(19) United States
(12) Patent Application Publication
(10) Pub. No.: US 2009/0103518 A1
(43) Pub. Date: Apr. 23, 2009

(54) CALL ORIGINATION BY AN APPLICATION SERVER IN AN INTERNET PROTOGOL MULTIMEDIA CORE NETWORK SUBSYSTEM

(75) Inventors: Mei Yu, Elk Grove, IL (US); Uri S. Baniel, Highland Park, IL (US); Srinivasan Krishnamoorthy, Nashua, NH (US); Miguel Angel Munoz, Madrid (ES); Jose Miguel Torres, Madrid (ES); Luis F. Velarde, Madrid (ES)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/874,242

(22) Filed: Oct. 18, 2007

(51) Int. Cl. H04L 12/66

(52) U.S. Cl. 370/352

(57) ABSTRACT

A system and method for call origination by an application server in an internet protocol multimedia core network subsystem includes a first step of providing a public user identity for a user. A next step includes storing a service parameter in a service profile of the user, the service parameter indicating whether to allow/disallow the application server to initiate call requests on behalf of the public user identity. If the service parameter allows the application server to initiate call requests, the system unblocks calls originated by the application server on behalf of the user. If the service parameter disallows the application server to initiate call requests, the system blocks calls originated by the application server on behalf of the user.

### FIELD OF THE INVENTION

The present invention relates in general to communication systems and more specifically to techniques for call origination in an internet protocol multimedia subsystem.

### BACKGROUND OF THE INVENTION

Recent technology innovations have expanded the capabilities of the Internet to include communication services. One such service for multimedia communication provides a call control protocol for use in an Internet Protocol (IP) Multimedia Core Network Subsystem (IMS). IMS conforms to Session Initiation Protocol (SIP) and Session Description Protocol (SDP), as are known in the art, and where all IMS entities are allocated an IP address. In IMS a mobile terminal or communication device, called User Equipment (UE) herein, provides the SIP User Agent (UA) role. A Call Session Control Function (CSCF) provides the SIP proxy role.

In IMS an Application Server (AS) can also provide the SIP UA role and provide call control for third party registrants (e.g. UEs) in the IMS. Typically, the UE or Subscriber is allocated a private user identity by a home communication network operator, such as a Home Subscriber System (HSS). The private user identity is available to the SIP application within the UE. The UE is also allocated at least one public user identity (PUI) provisioned on the HSS. The PUI is of the form of a SIP URI. A PUI may be shared among multiple UEs having different private user identities and IP addresses. The IMS provides a “trust domain” of asserted identities that all belong to the same operator network or have previous arrangements with the same operator network. An asserted identity takes the form of a P-Asserted-Identity header in SIP protocol. A UE is required to submit a PUI, private user identity, and a domain name in a registration request in the IMS. Such registration request can receive an Authorized or Unauthorized response from the IMS.

An Application Server (AS) can support registration on behalf of a known UE. In particular, upon receipt of a third party registration request, the AS may subscribe (using SIP URI) on behalf of the PUI registered at a Serving CSCF (S-CSCF). In this way, the AS can act as an originating UA. In the current case, the AS must be within the same trust domain as the S-CSCF to which the request will be sent. When sending an initial request on behalf of a PUI, the AS inserts a route header pointing to the S-CSCF where the PUI is registered or hosted (i.e. unregistered) or to the I-CSCF, serving as entry point of the PUI's network. The AS can obtain the S-CSCF address by either querying the Home Subscriber System of the UE or during third-party registration.

For the use of a P-Asserted-Identity by the AS, a request is generated either as if it was originated by the UE (where the AS inserts a P-Asserted-Identity representing the PUI of the UE), or is generated by the AS supporting a service identified by a Public Service Identity (PSI), where the AS inserts a P-Asserted-Identity containing the PSI of the AS.

However, these procedures are only applicable within a trust domain of the AS and S-CSCF. In particular, with the current IMS protocol, the AS is only allowed to originate a call on behalf of a local network IMS subscriber, and the AS is only allowed to send the call to the serving CSCF of the originating subscriber. This scenario is not completely sufficient for an AS's needs. Any particular IMS AS will only have knowledge of an IMS subscriber that also happens to subscribe to the AS hosted service. An AS call origination on behalf of a subscriber can happen on IMS origination path as well as termination path. This requires the S-CSCF (origination or termination S-CSCF) that receives such call origination to have the ability to send the call to the S-CSCF of the subscriber who is the logical originator of the call. However, this scenario does not provide any allocation for a non-subscribing UE.

What is needed is an enhancement to IMS to allow an IMS to originate calls on behalf of a non-subscribing UE.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a diagram illustrating an exemplary IMS call environment, in accordance with the present invention; and

FIG. 2 is a flow chart illustrating a method, in accordance with the present invention.

### DETAILED DESCRIPTION OF THE PREFERRED EMBODIMENTS

The present invention defines a call control protocol for use in an Internet Protocol Multimedia Core Network Subsystem (IMS). In overview, the present invention provides enhancements to the IMS network in order to support an AS in originating calls on behalf of any user, including non-subscribers to IMS. In the prior art, when the AS originates a call on behalf of a non-IMS user, the call would be rejected by the network.

The present invention provides an enhancement to the IMS standard in order to allow/not allow an AS to originate calls on behalf of a user (Public User Identity). Two different embodiments cases are described herein; a) for a user not belonging to the originating IMS network (i.e. not provisioned as such in HSS), wherein the user can be an IMS user but belonging to a different IMS network, or the user is not an IMS user, and b) for a user belonging to the originating IMS network (i.e. provisioned as such in HSS), which is similar to the exist case in the IMS standards with additional enhancements described below.

Advantageously, the present invention allows the ability to block/unblock calls originated by AS on behalf of a user. This is only defined in current IMS standard as part of the “trust domain” concept, but that concept does not allow the ability to block/unblock calls on a per user basis. In addition, the present invention allows transit functionality at the originating network, to pass communications through the network, whereas the current IMS standard only describes a transit function at terminating network for communications.

As used herein, the terms such as user equipment (UE) or communication device generally refer to end user devices such as fixed or/and WiFi sip phones, cellular or mobile radiotelephones, WiMax sip UA, two-way radios, messaging devices, personal digital assistants, personal assignment pads, personal computers equipped for wireless operation, a cellular handset or device, or the like, or equivalents thereof provided such units are arranged and constructed for operation in accordance with the various concepts and principles of the present invention and operating under appropriate specifications, standards, and protocols as discussed and described herein. In the example herein. IMS is an overlay technology, which doesn't address under layers, as it can be from ethernet, WiFi, WiMax, Cellular, to Cable set top box or DSL/DSLAM. It should be noted that the present invention is applicable to any type of access that provides an IP network layer that desires to use IMS as the application layer.

The principles and concepts discussed and described may be particularly applicable to communication units, devices, and systems providing or facilitating packet based multimedia communications services or voice, data, or messaging services over communication networks, such as conventional two way systems and devices, various cellular phone systems including analog and digital cellular, CDMA (code division multiple access) and variants thereof, GSM (Global System for Mobile communications), GPRS (General Packet Radio System), 2.5 G and 3G systems such as UMTS (Universal Mobile Telecommunication Service) systems, Integrated Digital Enhanced Networks, and variants or evolutions thereof. The principles and concepts described herein may further be applied in devices or systems with shorter range communications capabilities, such as IEEE 802.xx, Bluetooth, Wi-Fi or WiMAX and the like that preferably utilize CDMA, frequency hopping, orthogonal frequency division multiplexing, or TDMA access technologies and one or more of various networking protocols, such as TCP/IP (Transmission Control Protocol/Internet Protocol), IPX/SPX (Inter-Packet Exchange/Sequential Packet Exchange), Net BIOS (Network Basic Input Output System) or other protocol structures.

Further in accordance with various exemplary and alternative exemplary embodiments, the packet based RAN can include a Code Division Multiple Access (CDMA) RAN, a Global System Mobile (GSM) RAN, Universal Mobile Telecommunication System (UMTS) RAN, a Data Only (DO) RAN, a High Rate Packet Data Access (HRPDA) RAS, a Wireless Local Area Network (WLAN) RAN, or an Evolution Data Voice (EVDV) RAN. The exemplary RAN should support communications under the IP Multimedia Core Network Subsystem (IMS) specifications, for example as outlined in the Third Generation Partnership Project (3GPP) Technical Specification (TS) 24.229 for communications using Session Initiation Protocol (SIP), Session Description Protocol (SDP) and variants thereof. It should be noted that in accordance with the above noted standards, such as 3GPP release 7 IMS specification TS 24.229, multimedia streams can be transmitted over RTP/UDP (Real Time Transfer Protocol/Universal Datagram Protocol).

It will be appreciated that other 3GPP specifications and standards may also be relevant herein. Further in accordance with various exemplary embodiments, the present invention can be implemented as a higher layer, such as application layer software application, in which case lower protocol layers, such as the data link layers, can be interchangeable without departing from the intended scope of the invention, provided they support packet switched communication.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. The invention may further include a process with steps, procedures, or the like. Where a plurality of processes or steps are indicated, they may be performed in any order, unless expressly and necessarily limited to a particular order. Steps or processes that are not so limited may be performed in any order. In certain cases, these steps or processes may be repeated a number of time or may loop infinitely as required or until a particular event occurs or the like.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the present invention.

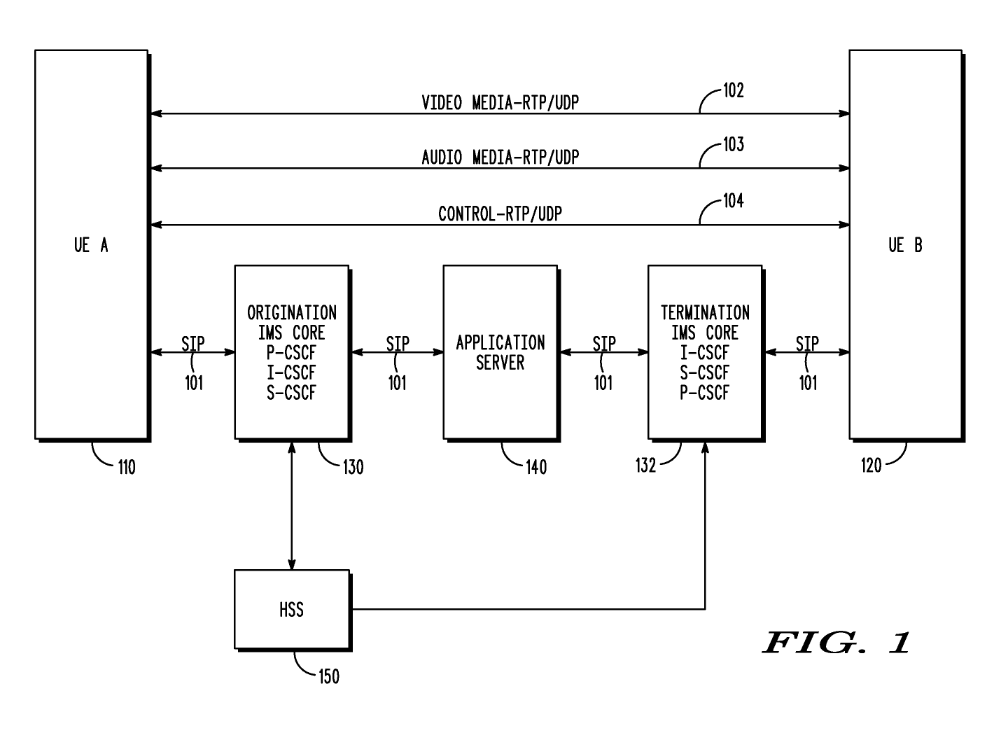

FIG. 1 is a diagram illustrating an exemplary IMS call environment, in accordance with the present invention. An originating communication unit 110 associated with, for example User Equipment (UE) A, desires to engage in a communication session with a target communication unit 120 associated, for example with UE B, so that a video media stream 102 and an audio media stream 103 can be exchanged therebetween, for example in accordance with IMS (Internet protocol Multimedia Subsystem) and SIP procedures. It will be appreciated that the session would be conducted in connection with an originating and/or terminating Internet Protocol Multimedia Subsystem (IMS) core 130, 132 and would be established through, for example, an application server (AS) 140 which can facilitate communication of the audio and video streams to the target communication unit 120 or other units in the call. The originating IMS core 130 acts as a proxy Serving Call State Control Function (P-CSCF), which is an initial interface (SIP Server) between the originating communication unit 110 and the originating IMS core 130. The P-CSCF does the basic validation of the UE identity, then passes the UE identity on to the registration process assigned as the originating S-CSCF 130. It should be noted that IMS call processing is split into origination and termination, each can have a different CSCF as well as AS.

The present invention provides an enhancement to the 3GPP TS 24.229 section 5.7.3 IMS standard in order to allow/not allow the AS 140 to originate calls on behalf of a user (Public User Identity), e.g. UE A 110, that is not a subscriber to the IMS network. Two different embodiments are described herein. The first embodiment involves a user not belonging to the originating IMS network (i.e. not provisioned as such in the Home Subscriber System (HSS) 150). This can include for example a user that is not an IMS user or a user that is an IMS user but belonging to a different IMS network. The second embodiment involves a user belonging to the originating IMS network (i.e. provisioned as such in HSS), which is similar to the case already described in the 3GPP TS 24.229 standard, although with novel differences as described below.

The first embodiment of the present invention allows the routing of calls originated by an AS 140 on behalf of an IMS user 110 that does not belong to the originating IMS network. In this embodiment, as the user is not an IMS user of the originating network (thus not provisioned in HSS), a new global system level parameter in the Interrogating CSCF (I-CSCF) is defined for the SIP signaling 101 in order to allow/not allow an AS to initiate call requests on behalf of this external user.

In operation, the first embodiment provides that the AS 140 initiates a call request on behalf of a user 110 that does not belong to the originating network. In particular, the AS 140 inserts the P-Asserted-Identity representing the public user identity of the originating user in a SIP INVITE in the signaling 101, In particular, the AS appends the “orig” parameter, which is the hard token in a call origination from the AS in a trust domain, to the URI in the topmost Route Header. In some cases, the AS may not be able to know if user is an IMS subscriber or not (unless it queries the HSS through the Sh interface), so in these cases the AS 140 can send the request to a pre-configured originating I-CSCF 130.

The I-CSCF 130 (acting as an originating I-CSCF) will perform Cx LIR to the HSS 150 and as the user 110 is not a subscriber of that IMS network, the HSS will return a SIP Diameter error, as is known in the art. Depending on the value set for the I-CSCF allow/disallow network server call origination parameter defined above for non-subscribing (external) users, the I-CSCF 130 will allow/not allow the request, as follows. In the case where the parameter is set to “allow” (for external users), the I-CSCF will route the request to the appropriate terminating I-CSCF 132 as per Request-URI/Route headers. In this case, the originating I-CSCF 130 is acting as a transit I-CSCF, unlike the current 3GPP TS 24.229 Release 7 standard where IMS transit is only defined for the terminating side. This is an enhancement to the current standard where the I-CSCF would have returned an unsuccessful SIP response: 404 (Not found) or 604 (Does not exist anywhere) in the case the user is not a user of that network. This new functionality is useful for an AS to execute services for many application service scenarios, e.g. non-IMS users can enjoy features like Find-me & Follow-me and Click-to-Dial. In case the parameter is set to “not allow” (for external users), the I-CSCF will reject the request.

In the case where the UE is an IMS subscriber, the originating I-CSCF will first find the originating S-CSCF assigned to the originating user and route the call to it. Then, the originating S-CSCF once finished the originating services procedures, route the call to terminating I-CSCF 132 based on request URI.

The second embodiment of the present invention describes allowing the routing of calls originated by AS 140 on behalf of an IMS user 110 subscribing to the originating IMS network. In this case, as the user is an IMS user of the originating IMS network (thus provisioned in HSS 150), a new SIP parameter in the user's Service Profile is defined in order to allow/not allow an AS to initiate call requests on behalf of that user (i.e. Public User Identity). It should be noted that the new SIP parameter is different than the global parameter defined for the first embodiment, but performs that same function, and is therefore referring to herein as a “service parameter”.

In operation, an AS 140 initiates a call request on behalf of an IMS user 110. In particular, the AS 140 inserts the P-Asserted-Identity representing the public user identity (from the initial IMS registration) of the user in a SIP INVITE in the signaling 101. In particular, the AS appends the “orig” parameter, which is the hard token in a call origination from the AS in a trust domain, to the URI in the topmost Route Header. As per the existing 3GPP TS 24.229 standard, there are two different cases here depending on whether the AS knows an S-CSCF of the public user identity on whose behalf the request is generated. If the AS knows the S-CSCF address for that user, where the public user identity on whose behalf the request is generated is registered or hosted (through a query in the unregistered case), then the AS 140 sends the request directly to the S-CSCF 130. However, if the AS does not know the S-CSCF address for that user, where the public user identity on whose behalf the request is generated is registered or hosted (through a query in the unregistered case), then AS sends the request to the entry point (e.g. I-CSCF) of the public user identity's network.

In the first case, the S-CSCF 130 (acting as the originating S-CSCF) will download the Service Profile of the user indicated in the P-Asserted-Identity and depending on the value set for the new SIP parameter in user's service profile defined above, it will allow/not allow the request.

In the second case, the I-CSCF 130 (acting as the originating I-CSCF) will perform Cx LIR (Location Information Request) to the HSS 150 and, in case the originating user (indicated by the P-Asserted-Identity) is not a local IMS network user, the HSS returns a Cx LIA message indicating the appropriate Diameter error (user not found), depending on the value set for the new I-CSCF SIP parameter defined above, it will allow/not allow the request. In case the originating user is a local IMS network user and, in case the SIP parameter is set to “allow” (for that user), the HSS 150 will return a Cx LIA (Location Information Author) message as per current standards. In case the SIP parameter is set to “not allow” (for that user), the HSS will return a Cx LIA message indicating the appropriate Diameter error (request not allowed). In this case, I-CSCF 130 will reject the request from AS 140.

Optionally, in case originating user is a local IMS user and, user's service profile indicate no network origination on behalf the user is allowed, it is also possible to return a Cx LIA message without error, as per current standards, and when the assigned S-CSCF 130 downloads the Service Profile of the user indicated in the P-Asserted-Identity, depending on the value set for the new SIP parameter defined above, S-CSCF will allow/not allow the request.

It will be appreciated by one of ordinary skill in the art that the interfaces between various modules described herein exist as software interfaces taking the form, for example, of function calls and the like, or may take the form of real time interrupt processing, or other software related processing. Alternatively, the functionality and interfaces may exist in hardware, or may be a combination of hardware and software. Bearer requirements involve an exemplary radio access network providing bearers to transport the application flows as noted herein. The bearer requirements to support the services described herein are consistent with TS 24.229 section 5.7.3.

It will be appreciated from the above discussion that many of the features of the present invention are susceptible to being implemented in a software program such as an application program or in a series of intercommunicating software programs, application, routines, modules, operating systems and the like. In addition, much of the functionality can be conducted as a method or procedure with a series of steps or the like.

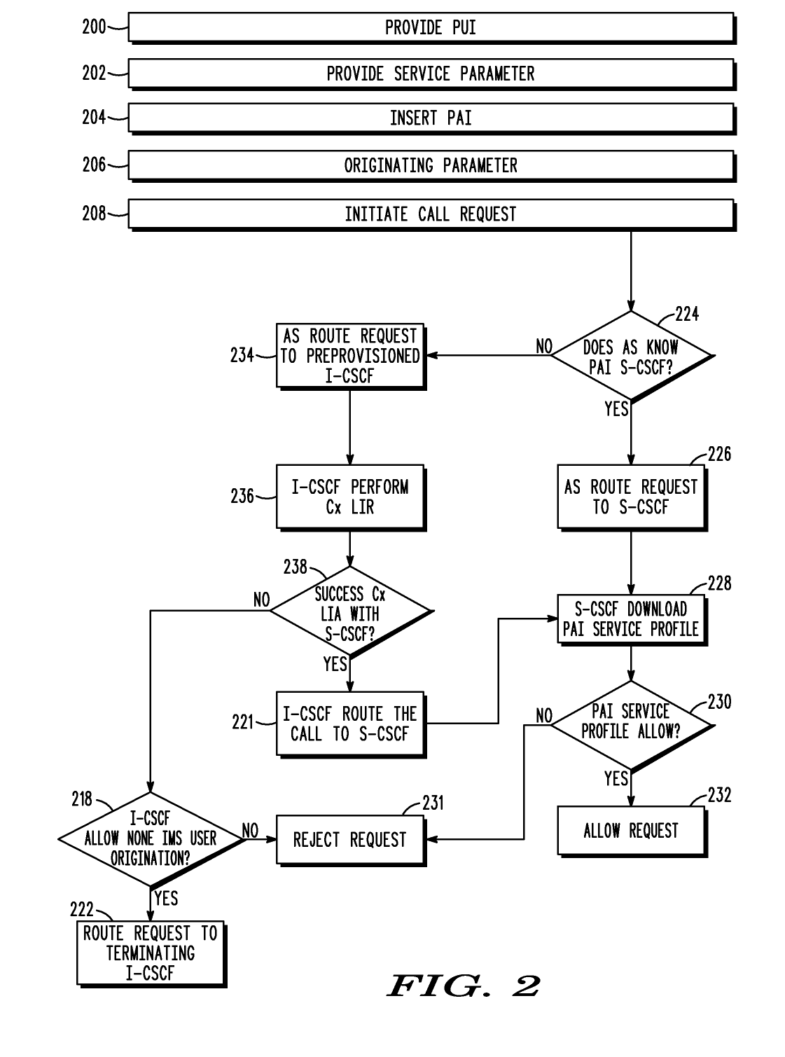

FIG. 2 illustrates an exemplary method for call origination by an application server in an internet protocol multimedia core network subsystem (IMS). The method includes a first step 200 of providing a public user identity for a user. A next step 202 includes providing a service parameter indicating whether to allow/disallow the application server to initiate call requests on behalf of the public user identity. A next step 204 includes inserting a P-Asserted-Identity (PAI) representing the public user identity of the user. A next step 206 includes appending a call originating parameter to the URI in a topmost Route Header. A next step 208 includes initiating a call on behalf of the user.

A next step 224 includes the application server determining if the user is a subscriber to an originating IMS network and whether the application server knows 224 a serving call session control function (S-CSCF) address for that user, where the public user identity (i.e. PAI) on whose behalf the request is generated.

If the AS knows the PAI S-CSCF address, then the service parameter of step 202 is included in a service profile of the user, which is subsequently downloaded 228 from a Home Subscriber System of the user. In this case, the user service profile flag will be part of the user profile, and gets delivered from HSS to S-CSCF via a Cx Diameter interface. A next step 226 includes the AS sending the request directly to the serving call session control function. A next step 228 includes downloading the service profile of the user indicated in the P-Asserted-Identity by the serving call session control function (S-CSCF) to obtain the service parameter. If the service parameter of the PAI service profile is set to “allow” 230, a next step 232 includes allowing the request for the application server to initiate calls for the user by unblocking calls originated by the application server on behalf of the user. If the service parameter is set to “not allow” 230, a next step 231 includes rejecting the request by the application server to initiate calls for the user by blocking calls originated by the application server on behalf of the user.

If it can not be determined 224 if user is not a subscriber to an originating IMS network, or where the application server does not know 224 a serving call session control function (S-CSCF) address for the public user identity (i.e. PAI) on whose behalf the request is generated, then the service parameter of step 202 is defined as a global system level parameter in an interrogating call session control function. The global parameter is local to I-CSCF provisioning.

A next step 234 includes sending a request to an entry point of the public user identity's network, i.e. a pre-provisioned interrogating call session control function (I-CSCF), to determine if the user is an IMS subscriber. A next step 236 includes performing a Cx Location Information Request to a local network home subscriber system (HSS) of the user, which returns a Cx Location Information Answer (Cx LIA) message indicating success or not (i.e. with no error or with an error).

If successful, a next step 221 includes routing the call to an appropriate originating serving call session control function (S-CSCF) as indicated in HSS response (the S-CSCF assigned for originating user), and the flow continues at step 228.

If unsuccessful, in case HSS returns a “user not found” error to indicate this is not an IMS user (NOTE: this flow shows one option where HSS returns positive response always for an IMS user regardless IMS user's profile have user level network origination allow or disallow. Another option is not show in this flow chart where HSS will look into user's profile on receipt of I-CSCF Cx LIR query), the interrogating call session control function will then determine 218 whether allow non-IMS user origination. If not, the originating I-CSCF will reject 231 the request by the application server to initiate calls for the user by blocking calls originated by the application server on behalf of the user. If so, the originating I-CSCF will route 222 the call to an appropriate terminating interrogating call session control function (I-CSCF) as per Request-URI.

In summary, the present invention provides a method for an application server to originate a call on behalf of any network users, by providing a new parameter at I-CSCF and in the service profile of user in the HSS to allow/disallow an AS to initiate call requests on behalf of any public user identity, even that of a non-IMS user. A new call handling mechanism is introduced in the I/S-CSCF to utilize the above new service parameter to allow/disallow call handling by AS for IMS and non-IMS subscribers. This will give IMS network many interesting advanced service abilities by handling network owned routing indicator without having to provision these routing string/indicator on the HSS as a subscriber or PSI.

Advantageously, the present invention provides the ability to block/unblock calls originated by AS on behalf of a user outside of a trusted domain concept. The trusted domain concept is defined in current standards, but that concept only allows transit function at the terminating network as in circuit to circuit network call in need of transit a IP IMS network, it also does not allow the provision to block/unblock calls on a per user basis, as in the present invention. In addition, the present invention performs transit functionality at the originating network, unlike the prior art.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for call origination by an application server in an internet protocol multimedia core network subsystem (IMS), the method comprising the steps of:
providing a public user identity for a user; and
providing a service parameter indicating whether to allow/disallow the application server to initiate call requests on behalf of the public user identity, wherein
if the service parameter allows the application server to initiate call requests, unblocking calls originated by the application server on behalf of the user, and
if the service parameter disallows the application server to initiate call requests, blocking calls originated by the application server on behalf of the user.

2. The method of claim 1, further comprising the step of determining that the user does not belong to an originating IMS network, and wherein the service parameter is a global system level parameter.

3. The method of claim 2, wherein the global system level parameter is in an interrogating call session control function.

4. The method of claim 1, further comprising the step of determining that the user belongs to an originating IMS network, and wherein the service parameter is a Session Initiation Protocol parameter.

5. The method of claim 4, wherein the Session Initiation Protocol parameter is in a user service profile in a home subscriber system of the user.

6. The method of claim 1, further comprising the steps of:
initiating a call on behalf of the user, inserting a P-Asserted-Identity representing the public user identity of the user, and
appending a call originating parameter to the URI in a topmost Route Header.

7. A method for call origination by an application server in an internet protocol multimedia core network subsystem (IMS), the method comprising the steps of:
providing a public user identity for a user;
providing a service parameter indicating whether to allow/disallow the application server to initiate call requests on behalf of the public user identity;
inserting a P-Asserted-Identity representing the public user identity of the user;
appending a call originating parameter to the URI in a topmost Route Header; and
initiating a call on behalf of the user, wherein
if the service parameter allows the application server to initiate call requests, unblocking calls originated by the application server on behalf of the user, and
if the service parameter disallows the application server to initiate call requests, blocking calls originated by the application server on behalf of the user.

8. The method of claim 7, further comprising the step of failing to determine if the user is an IMS subscriber, further comprising the step of sending a request to a pre-configured interrogating call session control function to determine if the user is an IMS subscriber.

9. The method of claim 7, further comprising the step of determining that the user does not belong to an originating IMS network, and wherein the service parameter is a global system level parameter in an interrogating call session control function.

10. The method of claim 8, further comprising the steps of:
performing a Cx Location Information Request to a home subscriber system of the user;
returning an error message by the home subscriber system, and
if the global system level parameter is set to “allow”, routing the request to an appropriate terminating interrogating call session control function as per Request-URI/Route headers, and
if the global system level parameter is set to “not allow”, the interrogating call session control function will reject the request.

11. The method of claim 7, further comprising the step of determining that the user belongs to an originating IMS network, wherein the providing step includes including the service parameter into a service profile of the user and downloading the service profile from a Home Subscriber System of the user.

12. The method of claim 11, wherein if the application server knows a serving call session control function address for that user, where the public user identity on whose behalf the request is generated, further comprising the step of sending the request directly to the serving call session control function.

13. The method of claim 12, further comprising the steps of:
downloading the service profile of the user indicated in the P-Asserted-Identity by
the serving call session control function, and
if the service parameter is set to “allow”, allowing the request, and
if the service parameter is set to “not allow”, rejecting the request.

14. The method of claim 11, wherein if the application server does not know a serving call session control function address for that user, where the public user identity on whose behalf the request is generated, further comprising the step of sending the request to an entry point of the public user identity's network.

15. The method of claim 14, further comprising the steps of:
performing a Cx Location Information Request to the home subscriber system, and
if the service parameter is set to “allow”, returning a Cx Location Information Author message and allowing the request, and
if the service parameter is set to “not allow”, returning a Cx Location Information Author message indicating an error and rejecting the request.

16. The method of claim 14, further comprising the steps of:
returning a Cx Location Information Author message;
downloading the service profile of the user indicated in the P-Asserted-Identity, and
if the service parameter is set to “allow”, allowing the request, and
if the service parameter is set to “not allow”, rejecting the request.

17. A system for call origination by an application server in an internet protocol multimedia core network subsystem, the system comprising:
a communication device having a public user identity;
a service parameter indicating whether to allow/disallow the application server to initiate call requests on behalf of the public user identity;
a proxy server controlling call origination in response to the service parameter; wherein
if the service parameter allows the application server to initiate call requests, the proxy server unblocks calls originated by the application server on behalf of the user, and
if the service parameter disallows the application server to initiate call requests, the proxy server blocks calls originated by the application server on behalf of the user.
